(19) United States
(12) Patent Application Publication
(10) Pub. No.: US 2014/0204049 A1
(43) Pub. Date: Jul. 24, 2014

(54) DISPLAY APPARATUS WITH TOUCH SENSING FUNCTION

(71) Applicant: HANNSTAR DISPLAY CORPORATION, New Taipei City (TW)

(72) Inventors: Kun-Hua Tsai, Tainan City (TW); Hsing-Ying Lee, Tainan City (TW); Ping-Yuan Su, Kaohsiung City (TW); Yu-Cheng Lin, Pingtung County (TW)

(73) Assignee: Hannstar Display Corporation, New Taipei City (TW)

(21) Appl. No.: 13/862,487

(22) Filed: Apr. 15, 2013

(30) Foreign Application Priority Data
Jan. 18, 2013 (CN) 201310020276.1

(51) Int. Cl. G06F 3/044

(52) U.S. Cl. CPC G06F 3/044
USPC 345/174

(57) ABSTRACT

The invention provides a display apparatus including a display panel, a display driving circuit and a touch sensing circuit. The display panel has a plurality of pixels arranged in an array, in which each of the pixels includes a liquid crystal capacitor. The display driving circuit is coupled to the display panel and configured to drive the pixels during a display period in a frame period to display images on the display panel. The touch sensing circuit is coupled to the display panel and configured to sense capacitance variations of the liquid crystal capacitors during a blanking period in the frame period, so as to generate a touch information.

### CROSS-REFERENCE TO RELATED APPLICATION

This application claims the priority benefit of China application serial no. 201310020276.1, filed on Jan. 18, 2013. The entirety of the above-mentioned patent application is hereby incorporated by reference herein and made a part of this specification.

### BACKGROUND OF THE INVENTION

1. Field of the Invention

The invention relates to a display apparatus, and more particularly to a display apparatus with touch sensing function.

2. Description of Related Art

A display apparatus with touch sensing function is generally implemented together by a touch system and a display system respectively being an independent system. Improvements to system integration and costs reduction are always the primary goals in electronics industries. With advances in technologies, touch panels can now successfully integrated with display panels, so users may operate electronic devices to execute required tasks directly though touches.

A touch display panel generally includes a plurality of pixels and a plurality of sensing units, wherein a display panel may be constructed by the pixels arranged in a 2D array, a touch panel may be constructed with the sensing units formed by touch electrodes built-in the display panel or attached on the display panel, so that the touch display panel may determine timings for updating frames and detecting touch points according to scan signals. In which, a panel structure having the touch electrodes of the touch panel built in the display panel is known as an in-cell touch display panel, which may effectively reduce overall thickness of the touch display panel.

However, structures of the display panel and the touch panel are always required to be utilized in realizing the function of image displaying and touch sensing at the same time, regardless of how advance the in-cell touch display panel is today. In other words, improvement to thickness and costs for the touch display panel combined by the display panel and the touch panel are thereby limited.

### SUMMARY OF THE INVENTION

The invention is directed to a display apparatus with touch sensing function with a new structure, the technical problem to be solved is to realize a touch sensing mechanism by sensing a capacitance variation of liquid crystal capacitors utilizing existing structure of the display panel, which is suitable in practical usage.

The purpose of the invention and the technical problems to be solved may be realized by technical solutions in the following embodiments. To achieve said purpose, the invention provides a display apparatus with touch sensing function including a display panel, a display driving circuit and a touch sensing circuit. The display panel has a plurality of pixels arranged in an array, in which each of the pixels includes a liquid crystal capacitor. The display driving circuit is coupled to the display panel and configured to drive the pixels during a display period in a frame period to display images on the display panel. The touch sensing circuit is coupled to the display panel and configured to sense capacitance variations of the liquid crystal capacitors during a blanking period in the frame period, so as to generate a touch information.

According to an embodiment of the invention, the display panel further includes a plurality of patterned common electrodes and each of the pixels further includes a pixel electrode, in which the patterned common electrodes are respectively overlapped with a part of the pixel electrodes, and each of the liquid crystal capacitors is built by each of the pixel electrodes with the patterned common electrodes overlapped thereto.

According to an embodiment of the invention, the display panel further includes a plurality of scan lines and a plurality of data lines, the pixels are respectively coupled to the corresponding scan lines and the corresponding data lines. The display driving circuit includes a gate driver, a source driver and a timing controller. The gate driver is coupled to the scan lines and configured to turn-on the pixels on the scan lines sequentially during the display period, and turn-on the pixels simultaneously during the blanking period. The source driver is configured to provide a plurality of pixel voltages to drive the pixels collaboratively with the gate driver. The timing controller is coupled to the gate driver and the source driver and configured to control operations of the gate driver and the source driver.

According to an embodiment of the invention, the source driver provides an initial voltage to driver the pixels during an initialization of the blanking period to initialize the liquid crystal capacitors. According to an embodiment of the invention, the gate driver is controlled by the timing controller to turn-on the scan lines with a first sequence during a first display period in a first frame period, and turn-on the scan lines with a second sequence being different to the first sequence during a second display period in a second frame period.

According to an embodiment of the invention, the touch sensing circuit includes a driving unit and a sensing unit. The driving unit is configured to provide the scan signal to the patterned common electrodes sequentially during the blanking period for the pixels to generate the sensing signals in response to the capacitance variations of the corresponding liquid crystal capacitors. The sensing unit is configured to receive the sensing signals during the blanking period and generate the touch information according to the sensing signals.

According to an embodiment of the invention, the display apparatus further include a bidirectional multiplexer. The bidirectional multiplexer has a terminal coupled to the source driver and the sensing unit and another terminal coupled to the scan lines of the display panel. In which, the bidirectional multiplexer is controlled to couple the data lines to the source driver during the display period to provide the pixel voltages respectively to the corresponding data lines, and switch the data lines to couple the sensing unit during the blanking period, thereby transmitting the sensing signals to the sensing unit through the corresponding data lines.

According to an embodiment of the invention, the display panel includes a first substrate, a common electrode layer, a pixel electrode layer, a liquid crystal layer and a second substrate. The common electrode layer is disposed on the first substrate, in which the patterned common electrodes are disposed in the common electrode layer. The pixel electrode layer is disposed on the common electrode layer, in which the pixel electrodes are disposed in the pixel electrode layer. The liquid crystal layer is disposed on the pixel electrode layer. The second substrate is disposed on the liquid crystal layer, in which the first substrate, the common electrode layer, the pixel electrode layer, the liquid crystal layer and the second substrate are stacked along a first direction, and the display panel is controlled by the display driving circuit to build an electric field along a second direction being perpendicular to the first direction.

According to an embodiment of the invention, the display panel is an in-plane switching (IPS) LCD panel.

According to an embodiment of the invention, the display panel is a fringe field switching (FFS) LCD panel.

The invention has obvious advantages and effects in comparing to the conventional technology. Based on the above disclosure, the display apparatus with touch sensing function of the invention has the following advantages and effects. The display apparatus with touch sensing function of the invention may realize a touch sensing mechanism by sensing capacitance variations of a liquid crystal capacitors utilizing existing structure of the display panel. Since no additional touch electrodes are required to be disposed, designing and manufacturing costs of the display apparatus may thereby be reduced.

Based on above, the invention provides a display apparatus including a display panel, a display driving circuit and a touch sensing circuit. The display panel has a plurality of pixels arranged in an array, in which each of the pixels includes a liquid crystal capacitor. The display driving circuit is coupled to the display panel and configured to drive the pixels during a display period in a frame period to display images on the display panel. The touch sensing circuit is coupled to the display panel and configured to sense capacitance variations of the liquid crystal capacitors during a blanking period in the frame period, so as to generate a touch information.

Above description is the summary of technical solution in the invention for those skilled in the art to understand technical features more clearly and implement the invention together with the embodiments in the specification. In order to the make the aforementioned and other objects, features and advantages of the present invention more comprehensible, preferred embodiments accompanied with figures are described in detail below.

### BRIEF DESCRIPTION OF THE DRAWINGS

FIG. 1 is a schematic view of circuits in a display apparatus according to an embodiment of the invention.

FIG. 2 is a cross-sectional structural schematic view illustrating a display panel according to an embodiment of the invention.

FIG. 3 is an equivalent circuit diagram of pixels depicted in FIG. 1.

FIG. 4 is a schematic view illustrating a driving sequence of a display apparatus during a frame period according to an embodiment of the invention.

FIG. 5 is a schematic view illustrating an operations of a display apparatus between a plurality of frame periods according to an embodiment of the invention.

### DESCRIPTION OF THE EMBODIMENTS

A display apparatus with touch sensing function is proposed according to embodiments of the invention, which may realize a touch sensing mechanism by sensing capacitance variations of liquid crystal capacitors utilizing existing structure of the display panel. Since no additional touch electrodes are required to be disposed, designing and manufacturing costs may thereby be reduced. In order to make the invention more comprehensible, embodiments are described below as the examples to prove that the invention can actually be realized. Moreover, elements/components/steps with same reference numerals represent same or similar parts in the drawings and embodiments.

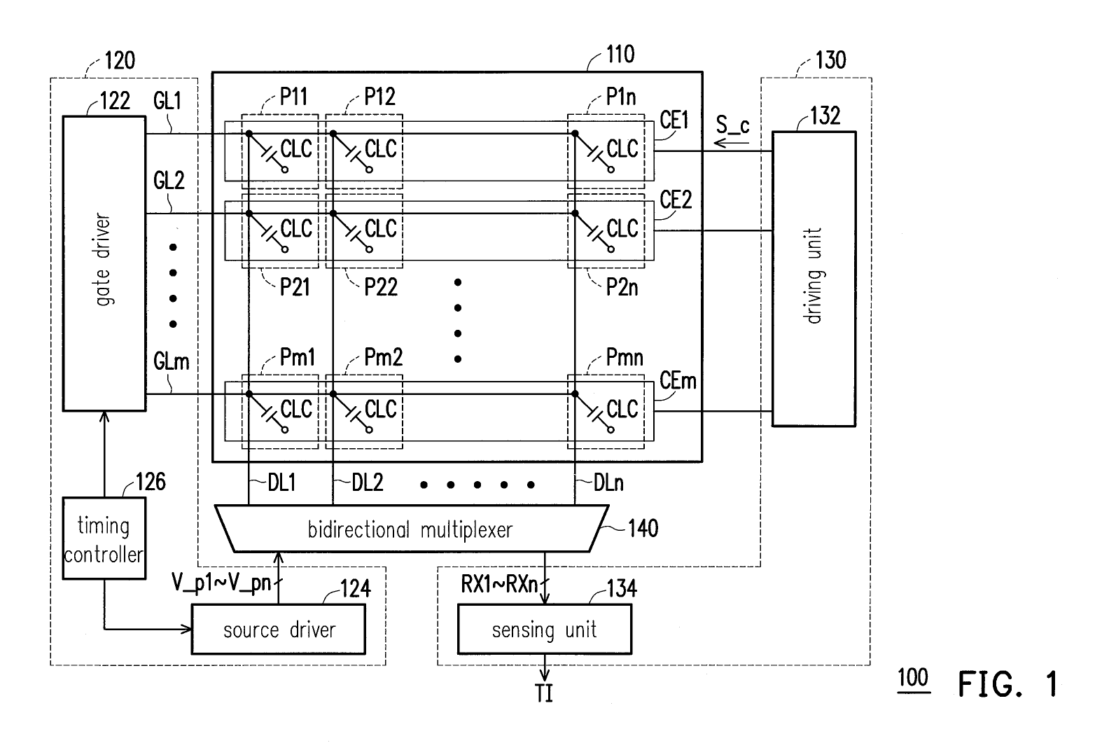

FIG. 1 is a schematic view of circuits in a display apparatus according to an embodiment of the invention. Referring to FIG. 1, a display apparatus 100 includes a display panel 110, a display driving circuit 120 and a touch sensing circuit 130. The display panel 110 has a plurality of pixels P11 to Pmn arranged in an array, in which each of the pixels P11 to Pmn includes a corresponding liquid crystal capacitor CLC, in which m and n are positive integers and values of the m and n may be adjusted according to actual requirement. The display driving circuit 120 and the touch sensing circuit 130 are respectively coupled to the display panel 110. The display driving circuit 120 is configured to drive each of the pixels P11 to Pmn of the display panel 110, so as to display images on the display panel 110. The touch sensing circuit 130 implements the touch sensing function for the display panel 110 by sensing a capacitance variation of the liquid crystal capacitor CLC in each of the pixels P11 to Pmn.

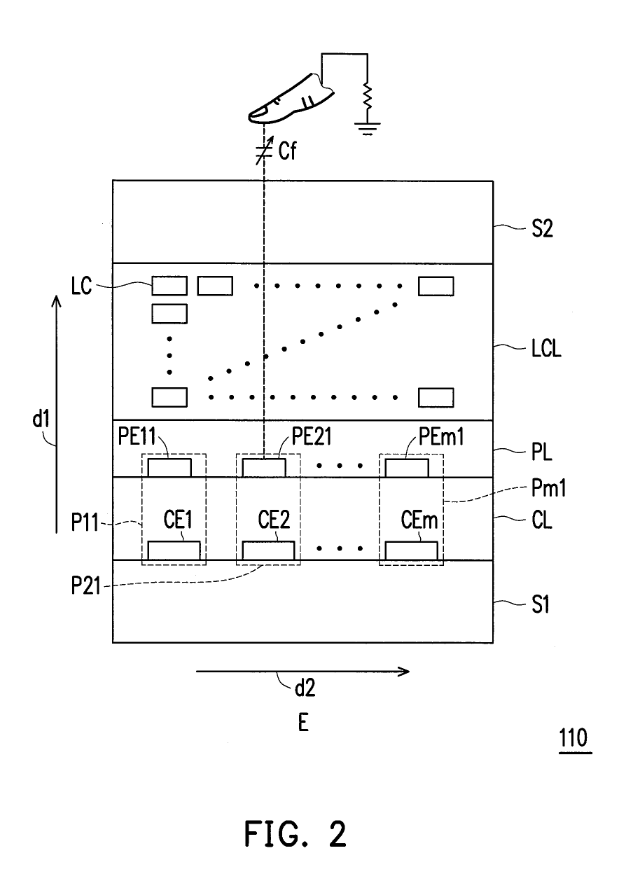

From structural viewpoint of the display apparatus 100, FIG. 2 is a cross-sectional structural schematic view illustrating the display panel depicted in FIG. 1. Referring to FIG. 1 and FIG. 2 together, the display panel 110 includes a first substrate S1, a common electrode layer CL, a pixel electrode layer PL, a liquid crystal layer LCL and a second substrate S2. In the display panel 110, a plurality of patterned common electrodes CE1 to CEm are disposed in the common electrode layer CL, a plurality of pixel electrodes respectively corresponding to the pixels P11 to Pmn (e.g., the pixel electrodes PE11 to PEm1 that respectively corresponding to the pixels P11 to Pm1) are disposed in the pixel electrode layer PL, and a plurality of liquid crystal molecules LC are disposed in the liquid crystal layer LCL.

Furthermore, the common electrode layer CL, the pixel electrode layer PL and liquid crystal layer LCL are sequentially stacked along a first direction d1 and disposed between the first substrate S1 and the second substrate S2. In which, each of the patterned common electrode CE1 to CEm is respectively overlapped with each row of the pixel electrodes in the pixel electrode layer PL. For example, the patterned common electrode CE1 is overlapped with the pixel electrodes corresponding to the pixels P11 to P1n, the patterned common electrode CE2 is overlapped with the pixel electrodes corresponding to the pixels P21 to P2n and the patterned common electrode CEm is overlapped with the pixel electrodes corresponding to the pixels Pm1 to Pmn. The liquid crystal capacitor CLC in each of the pixels P11 to Pmn is built by the corresponding pixel electrodes and the patterned common electrodes CE1 to CEm overlapped thereto.

According to the present embodiment, the display panel 110 is controlled by the display driving circuit 120 to build an electric field E along a second direction d2 being perpendicular to the first direction d1, so as to control an orientation of the liquid crystal molecules LC. In other words, the display panel 110 is a LCD panel structure utilizing a horizontal electric field parallel to the first substrate S1 and the second substrate S2.

More specifically, when a user touches the display panel 110 with a finger, a finger capacitor Cf may couple to the corresponding pixel electrode (such as PE21) according to a position being touched (i.e., a touch point), so as to change a capacitance of the corresponding liquid crystal capacitor CLC. As such, the touch sensing circuit 130 may determine the position of the touch point based on the capacitance variation of the liquid crystal capacitor CLC and output a corresponding touch information T1. Furthermore, in the display panel 110 driven by the horizontal electric field, the common electrode layer CL and the pixel electrode layer PL are disposed at the same side of the liquid crystal layer LCL and located between the first substrate S1 and the liquid crystal layer CLC. Therefore, once the second substrate S2 is touched by the finger of the user, the finger capacitor Cf may couple to the pixel electrode PE21 through the second substrate S2 and the liquid crystal layer LCL without being shielded by the common electrode layer CL.

It should be noted that, a stacked structure of the display panel 110 depicted in FIG. 2 is merely an example, any LCD panel structures without causing a shielding effect structurally to finger capacitor Cf may also be applied for the invention. For instance, the display panel 110 may be, for example, LCD panels driven by the horizontal electric field such as an in-plane switching (IPS) LCD panel or a fringe field switching (FFS) LCD panel.

From driving viewpoint of the display apparatus 100, in order to avoid mutual interference to mechanisms of image displaying and touch sensing in the display apparatus 100, the display driving circuit 120 and the touch sensing circuit 130 control the display panel 110 respectively during a display period and a blanking period in a frame period.

More specifically, the display driving circuit 120 may sequentially turn-on each row of the pixels P11 to Pmn during the display period in each frame period and output corresponding pixel electrodes V_p1 to V_pn to drive each of the pixels P11 to Pmn coordinated with the timing sequence of each row of the pixels P11 to Pmn being turned-on, so that display panel 110 may display a corresponding image. On the other hand, the touch sensing circuit 130 may provide a scan signal S_c to each row of the pixels P11 to Pmn of the display panel 110 sequentially during the blanking period in the frame period, so each of the pixels P11 to Pmn may transmit sensing signals RX1 to RXn back to the touch sensing circuit 130 in response to the scan signal S_c, such that the touch sensing circuit 130 may determine whether the corresponding pixels P11 to Pmn are touched according to the capacitance variation of the liquid crystal capacitor CLC thereby generating a touch information T1. In which, since the display period and the blanking period are two periods in the same frame period and not being overlapped with one another, the display panel 110 may display image without being interfered with the touch sensing mechanism.

More specifically, referring back to FIG. 1, the display panel 110 further includes a plurality of scan lines GL1 to GLm and a plurality of data lines DL1 to DLn being crisscross disposed with said scan lines, in which the pixels P11 to Pmn are respectively coupled to the corresponding scan lines GL1 to GLm and the corresponding data lines DL1 to DLn. Herein, a structure of the pixels P11 to Pmn in FIG. 1 is for illustration only rather than indicating that the liquid crystal capacitor CLC is coupled to cross points between the scan line GL1 to GLm and the data lines DL1 to DLn (detailed description of the equivalent circuit diagram will be illustrated in the embodiment below).

The display driving circuit 120 includes a gate driver 122, a source driver 124 and a timing controller 126. The gate driver 122 is coupled to the scan lines GL1 to GLm and configured to turn-on the pixels P11 to Pmn on the scan lines GL1 to GLm sequentially during the display period, and turn-on the pixels P11 to Pmn simultaneously during the blanking period. The source driver 124 is configured to provide a plurality of pixel voltages Vp1 to Vpn to drive the pixels P11 to Pmn coordinately with the gate driver 122. The timing controller 126 is coupled to the gate driver 122 and the source driver 124 and configured to control operations of the gate driver 122 and the source driver 124.

The touch sensing circuit 130 includes a driving unit 132 and a sensing unit 134. The driving unit 132 is configured to provide the scan signal S_c to the patterned common electrodes CE1 to CEm sequentially during the blanking period for the pixels P11 to Pmn to generate the sensing signals RX1 to RXn in response to the capacitance variation of the corresponding liquid crystal capacitor CLC. The sensing unit 134 is configured to receive the sensing signals RX1 to RXn during the blanking period and generate the touch information T1 according to the sensing signals RX1 to RXn.

The display apparatus 100 further includes a bidirectional multiplexer 140 to realize a switching function of the display panel 110 in between the display period and the blanking period. In which, a terminal of the bidirectional multiplexer 140 is coupled to the source driver 124 of the display driving circuit 120 and the sensing unit 134 of the touch sensing circuit 130, whereas another terminal of the bidirectional multiplexer 140 is coupled to the data lines DL1 to DLn of the display panel 110. According to the present embodiment, the bidirectional multiplexer 140 may switch the data lines DL1 to DLn to couple the source driver 124 of the display driving circuit 120 or the sensing unit of the touch sensing circuit 130 based on controlling of the timing controller 126 or an independent unit (not illustrated) of the display apparatus 110.

The bidirectional multiplexer 140 may couple the data lines DL1 to DLn to the source driver 126 during the display period to provide the pixel voltages V_p1 to V_pn respectively to the corresponding data lines DL1 to DLn. On the other hand, the bidirectional multiplexer 140 may switch the data lines DL1 to DLn to couple the sensing unit 134 during the blanking period to provide the sensing signals RX1 to RXn respectively to the sensing unit 314 through the corresponding data lines DL1 to DLn.

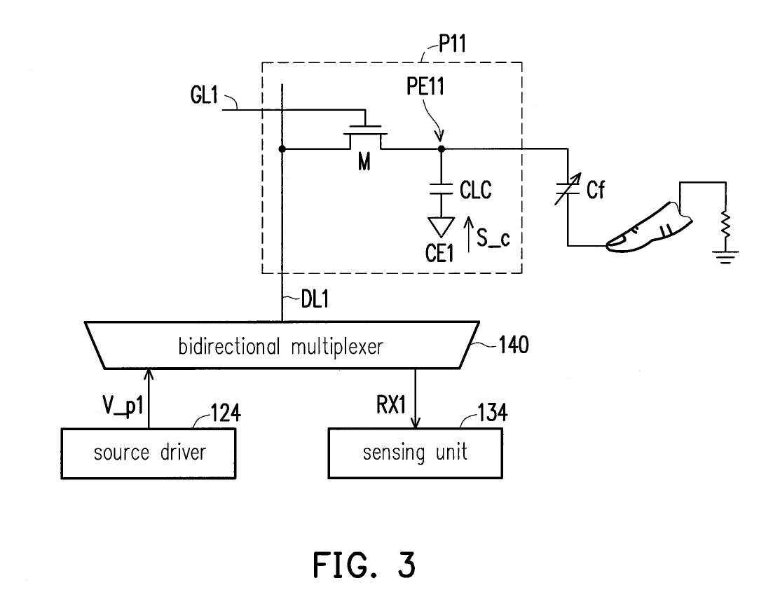

Take the equivalent circuit structure of the pixel P11 as an example, as shown in FIG. 3, the pixel P11 further includes an active device M having a first terminal coupled to the pixel electrode PE11, a second terminal coupled to the data line DL1 and a control terminal coupled to the scan line GL1. Referring to FIG. 2 and FIG. 3 together, when a driving sequence of the display apparatus 100 enters the display period, the bidirectional multiplexer 140 may couple the data line DL1 to the source driver 124 during the display period, so as to provide the corresponding pixel voltage V_p1 to the pixel electrode PE11 when the active device M is turned on under control of a signal on the scan line GL1.

On the other hand, when the driving sequence of the display apparatus 100 enters the blanking period, the bidirectional multiplexer 140 may switch the data line DL1 to couple the sensing unit 134. Since the active device M is constantly turned on during the blanking period under control of the signal on the scan line GL1, the pixel P11 may output the corresponding sensing signal RX1 to the sensing unit 134 through the data line DL1 in response to the scan signal S_c when the scan signal S_c of the driving unit 132 is provided to the patterned common electrode CE1. Since the level of the sensing signal RX1 may be changed with the capacitance variation of the liquid crystal capacitor CLC, the sensing unit 134 may determine whether the pixel P11 is touched by detecting the level variation of the sensing signal RX1. Take a structure of the finger capacitor Cf being an equivalent circuit connected to the liquid crystal capacitor CLC in parallel as an example, the finger capacitor Cf may connect the liquid crystal capacitor CLC in parallel so as to increase an overall equivalent capacitance when the pixel P11 is touched. Therefore, the level of the sensing signal RX1 output from the pixel P11 is relative lower than the pixel being touched. In this case, the sensing unit 134 may determine that the pixel P11 is touched on a basis of the level of the sensing signal RX1 being lower than a predetermined value thereby outputting the corresponding touch information. Similarly, under a structure of the finger capacitor Cf being an equivalent circuit connected to the liquid crystal capacitor CLC in series, similar mechanism of detecting the level of the sensing signal RX1 may also be used with reference to above description, so to determine whether the pixel P11 is touched.

Accordingly, by using the driving methods and structures as described above, the touch sensing function of the touch apparatus 100 may be implemented without disposing additional touch electrodes in the display panel 110. As a result, in compare to conventional touch sensing display apparatuses, the display apparatus 100 with touch sensing function according to the present embodiment of the invention may further reduce the designing and manufacturing costs of the display panel.

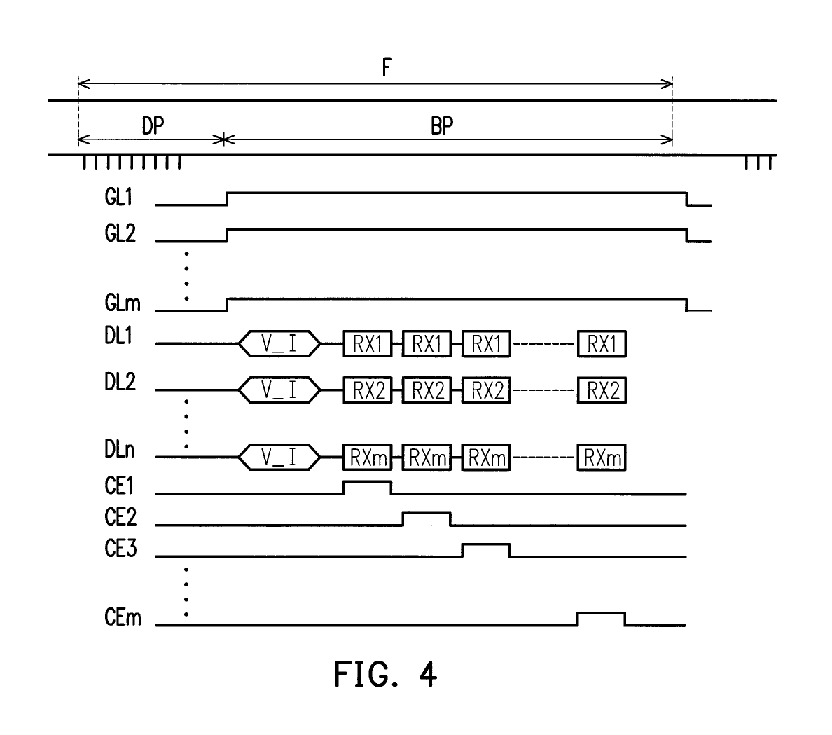

As to describe the embodiment of the invention more clearly, referring to FIG. 4, which is a schematic view illustrating a driving sequence of a display apparatus during a frame period according to an embodiment of the invention. Referring to FIG. 1 and FIG. 4 together, since a signal sequence of a display period DP in a frame period F is similar to a driving sequence of conventional LCD apparatus, thus related description is omitted herein. In which, proportional relation of the display period DP and a banking period BP is for illustration only, in practical application, lengths of the display period DP and the blanking period BP in the frame period F may be set by designers based on actual requirements, the invention is not limited thereto.

More specifically, when the display period DP is ended and the signal sequence continues to enter the blanking period BP, a gate driver 122 may enable the scan lines GL1 to GLm at the same time to turn-on all of the pixels P11 to Pmn, whereas the source driver 124 may provide an initializing voltage V_I at the same time to drive the pixels P11 to Pmn, so as to initialize the liquid crystal capacitor CLC in each of the pixels P11 to Pmn. Furthermore, said initializing voltage V1 is generated by the source driver 124 according to a black image data or a while image data configured for the liquid crystal capacitor CLC in each of the pixels P11 to Pmn to maintain at the same capacitance before sensing the touch sensing function, so as prevent misjudgment in sensing the touch sensing function.

In other words, the bidirectional multiplexer 140 may switch the data lines DL1 to DLn to couple the sensing unit 134 only when the liquid crystal capacitor CLC in each of the pixels P11 to Pmn is initialized instead of switching them at the beginning of the blanking period.

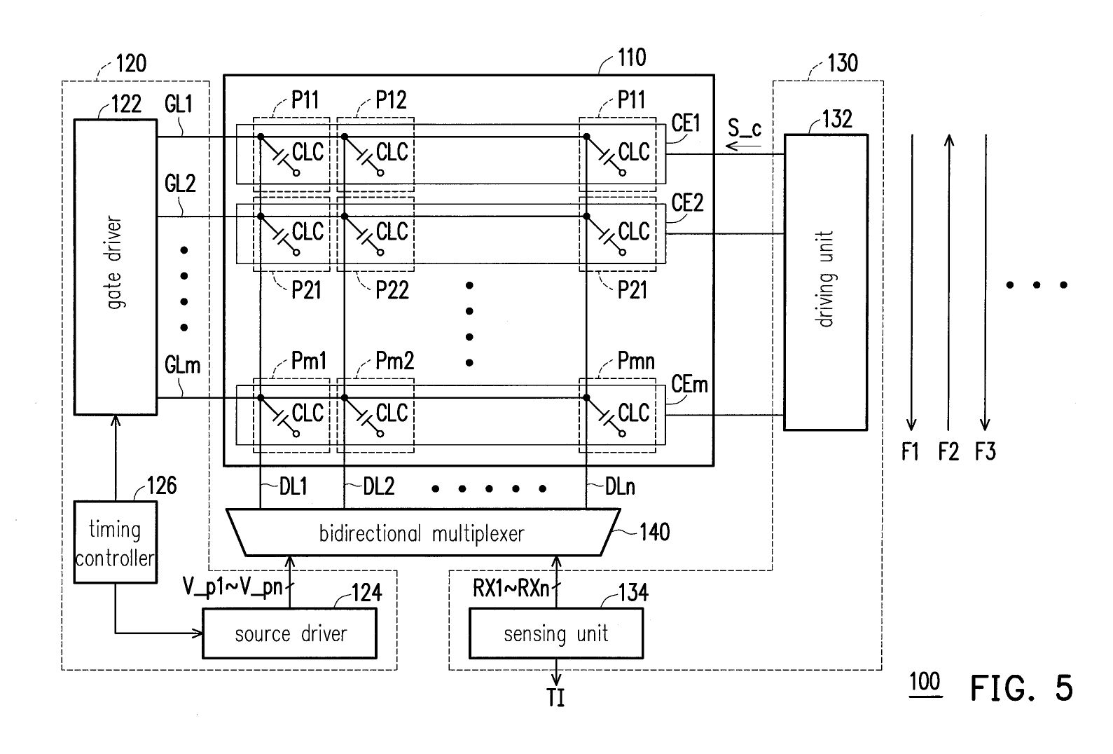

FIG. 5 is a schematic view illustrating an operations of a display apparatus between a plurality of frame periods according to an embodiment of the invention. Referring to FIG. 5, the gate driver 122 in the present embodiment may be controlled by the timing controller 126 to turn-on the pixels P11 to Pmn of the display panel 110 by utilizing different scanning sequences respectively during different frame periods (e.g., F1, F2 and F3). For instance, the gate driver 122 may turn-on the pixels P11 to Pmn on the scan lines GL1 to GLn during the display period in the frame period F1 with a sequence from top to bottom (i.e., a sequence from the pixel P11 to the pixel Pm1) and turn-on the pixels P11 to Pmn on the scan lines GL1 to GLn during the display period in the next frame period F2 with an alternative sequence from bottom to top (i.e., a sequence from the pixel Pm1 to the pixel P11). Sequences to turn-on the pixels P11 to Pmn in the subsequent frame periods are the same as above description being used sequentially in turns. With said driving method, a time for the source driver 124 to input the pixels voltage V_P to V_pn to each of the pixels P11 to Pmn is substantially the same as in each of the frame periods (i.e., F1, F2 and F3), so as to further improve in maintaining the image display quality of the display panel 110.

In view of above, the display apparatus with touch sensing function proposed in the embodiments of the invention may implement a touch sensing mechanism by sensing a capacitance variation of a liquid crystal capacitor with existing structure of the display panel. Since no additional touch electrodes are required to be disposed, designing and manufacturing costs of the display apparatus may thereby be reduced.

Disclosure as above is merely used for illustrating preferable embodiments of the invention instead of restricting the invention in any possible formats. Although the present invention has been disclosed by the above preferable embodiments, they are not intended to limit the present invention. It will be apparent to those skilled in the art that various modifications and variations can be made to the disclosed embodiments. It is intended that the specification and examples be considered as exemplary only, with a true scope of the disclosure being indicated by the following claims and their equivalents However, in view of the foregoing, it is intended that the invention cover modifications and variations of this invention provided they fall within the scope of the following claims and their equivalents.

What is claimed is:

1. A display apparatus with touch sensing function, comprising:
a display panel having a plurality of pixels arranged in an array, and each of the pixels comprises a liquid crystal capacitor;
a display driving circuit coupled to the display panel and configured to drive the pixels during a display period in a frame period to display images on the display panel; and
a touch sensing circuit coupled to the display panel and configured to sense capacitance variations of the liquid crystal capacitors during a blanking period in the frame period thereby generating a touch information.

2. The display apparatus with touch sensing function of claim 1, wherein the display panel further comprises a plurality of patterned common electrodes and each of the pixels further comprises a pixel electrode.

3. The display apparatus with touch sensing function of claim 2, wherein the patterned common electrodes are respectively overlapped with a part of the pixel electrodes, and the liquid crystal capacitors are respectively built by each of the pixel electrodes with the patterned common electrodes overlapped thereto.

4. The display apparatus with touch sensing function of claim 2, wherein the display panel further comprises a plurality of scan lines and a plurality of data lines, the pixels are respectively coupled to the corresponding scan lines and the corresponding data lines, and the display driving circuit comprises:
a gate driver coupled to the scan lines and configured to turn-on the pixels on the scan lines sequentially during the display period, and turn-on the pixels simultaneously during the blanking period;
a source driver configured to provide a plurality of pixel voltages to drive the pixels collaboratively with the gate driver; and
a timing controller coupled to the gate driver and the source driver and configured to control operations of the gate driver and the source driver.

5. The display apparatus with touch sensing function of claim 4, wherein the source driver provides an initial voltage to driver the pixels during an initialization of the blanking period to initialize the liquid crystal capacitors.

6. The display apparatus with touch sensing function of claim 4, wherein the gate driver is controlled by the timing controller to turn-on the scan lines with a first sequence during a first display period in a first frame period.

7. The display apparatus with touch sensing function of claim 6, wherein the gate driver is controlled by the timing controller to turn-on the scan lines with a second sequence being different to the first sequence during a second display period in a second frame period.

8. The display apparatus with touch sensing function of claim 4, wherein the touch sensing circuit comprising:
a driving unit configured to provide a scan signal to the patterned common electrodes sequentially during the blanking period for each row of the pixels to generate a plurality of sensing signals in response to the scan signal; and
a sensing unit configured to receive the sensing signals during the blanking period and generate the touch information according to the sensing signals.

9. The display apparatus with touch sensing function of claim 8, wherein the display apparatus further comprising:
a bidirectional multiplexer having a terminal coupled to the source driver and the sensing unit and another terminal coupled to the scan lines of the display panel.

10. The display apparatus with touch sensing function of claim 9, wherein the bidirectional multiplexer is controlled to couple the data lines to the source driver during the display period to provide the pixel voltages respectively to the corresponding data lines.

11. The display apparatus with touch sensing function of claim 9, wherein the bidirectional multiplexer is controlled to switch the data lines to couple the sensing unit during the blanking period, thereby transmitting the sensing signals to the sensing unit through the corresponding data lines.

12. The display apparatus with touch sensing function of claim 4, wherein the display panel further comprising:
a first substrate;
a common electrode layer disposed on the first substrate, and the patterned common electrodes are disposed in the common electrode layer;
a pixel electrode layer disposed on the common electrode layer, and the pixel electrodes are disposed in the pixel electrode layer;
a liquid crystal layer disposed on the pixel electrode layer; and
a second substrate disposed on the liquid crystal layer.

13. The display apparatus with touch sensing function of claim 12, wherein the first substrate, the common electrode layer, the pixel electrode layer, the liquid crystal layer and the second substrate are stacked along a first direction, and the display panel is controlled by the display driving circuit to build an electric field along a second direction being perpendicular to the first direction.

14. The display apparatus with touch sensing function of claim 1, wherein the display panel is an in-plane switching (IPS) LCD panel.

15. The display apparatus with touch sensing function of claim 1, wherein the display panel is a fringe field switching (FFS) LCD panel.

16. A driving method for a display apparatus with touch sensing function, comprising steps of:
providing a plurality of pixels with liquid crystal capacitors;
driving a plurality of pixels during a display period in a frame period to display images; and
sensing capacitance variations of the liquid crystal capacitors during a blanking period in the frame period thereby generating a touch information.

17. The driving method for the display apparatus with touch sensing function of claim 16, further comprising a step of:
turning on the pixels sequentially during the display period and the blanking period.

18. The driving method for the display apparatus with touch sensing function of claim 16, further comprising steps of:
providing an initial voltage to the pixels during an initialization of the blanking period; and
initializing the liquid crystal capacitors.

19. The driving method for the display apparatus with touch sensing function of claim 16, further comprising steps of:
providing a scan signal to a plurality of patterned common electrodes sequentially during the blanking period for each row of the pixels; and
generating a plurality of sensing signals in response to the scan signal.

20. The driving method for the display apparatus with touch sensing function of claim 19, further comprising steps of:
receiving the sensing signals during the blanking period; and
generating the touch information according to the sensing signals.
